(19) United States
(12) Patent Application Publication
(10) Pub. No.: US 2022/0003181 A1
(43) Pub. Date: Jan. 6, 2022

(54) INTERNAL COMBUSTION ENGINE CONTROL APPARATUS

(71) Applicant: c/o Honda Motor Co., Ltd., Tokyo (JP)

(72) Inventors: Masaya Agata, Tokyo (JP); Hiroki Miyazono, Tokyo (JP); Keisuke Ohta, Tokyo (JP); Daisuke Shiomi, Wako-shi (JP); Yuichi Masukake, Wako-shi (JP)

(21) Appl. No.: 17/361,490

(22) Filed: Jun. 29, 2021

(30) Foreign Application Priority Data
Jul. 3, 2020 (JP) 2020-115746

(51) Int. Cl. F02D 41/18; F02D 41/00; F02D 41/26; F02P 5/15; F02D 41/12

(52) U.S. Cl. CPC F02D 41/182; F02D 41/0087; F02D 41/0097; F02D 41/26; F02P 5/1512; F02D 2200/602; F02D 41/123; F02D 2200/021; F02D 2200/0802; F02D 2200/1002; F02D 2200/101; F02P 5/1504

(57) ABSTRACT

An internal combustion engine control apparatus including a rotational speed sensor detecting a rotational speed of an internal combustion engine, an intake air amount sensor detecting an amount of an intake air supplied into a combustion chamber, a command detector detecting a command of a deceleration of a vehicle on which the internal combustion engine is mounted or a torque down of the internal combustion engine, and a microprocessor. The microprocessor is configured to perform: determining whether a retard condition of an ignition timing is satisfied based on a value detected by the rotational speed sensor or the intake air amount sensor when the command is detected by the command detector, and controlling an ignition part so as to perform an ignition-timing retard control to delay the ignition timing of the ignition part when it is determined that the retard condition is satisfied.

### CROSS-REFERENCE TO RELATED APPLICATION

This application is based upon and claims the benefit of priority from Japanese Patent Application No. 2020-115746 filed on Jul. 3, 2020, the content of which is incorporated herein by reference.

### BACKGROUND OF THE INVENTION

### Field of the Invention

This invention relates to an internal combustion engine control apparatus configured to control an internal combustion engine so as to produce an effect of generating exhaust noise.

### Description of the Related Art

Conventionally, there has been a known apparatus in which a pseudo exhaust sound of an internal combustion engine is generated from a speaker mounted on a vehicle at a predetermined timing according to an operation of an accelerator pedal of a driver. Such an apparatus is described, for example, in Japanese Unexamined Patent Publication No. 2013-167851 (JP2013-167851A).

However, since the pseudo exhaust sound differs from the actual exhaust sound, in a configuration that generates the pseudo exhaust sound as in the apparatus described in JP2013-167851A, there is a possibility that the driver may be discomforted.

### SUMMARY OF THE INVENTION

An aspect of the present invention is an internal combustion engine control apparatus for controlling an internal combustion engine including a fuel supply part configured to supply a fuel into a combustion chamber in a cylinder and an ignition part configured to ignite a mixture containing the fuel supplied into the combustion chamber. The internal combustion engine control apparatus includes: a rotational speed sensor configured to detect a rotational speed of the internal combustion engine or a physical amount having a correlation with the rotational speed; an intake air amount sensor configured to detect an amount of an intake air supplied into the combustion chamber or a physical amount having a correlation with the amount of the intake air; a command detector configured to detect a command of a deceleration of a vehicle on which the internal combustion engine is mounted or a command of a decrease of a torque output from the internal combustion engine; and an electronic control unit including a microprocessor and a memory connected to the microprocessor. The microprocessor is configured to perform: controlling the fuel supply part and the ignition part; and determining whether a retard condition of an ignition timing is satisfied based on a value detected by the rotational speed sensor or the intake air amount sensor when the command is detected by the command detector. The microprocessor is configured to perform the controlling including controlling the ignition part so as to perform an ignition-timing retard control to delay the ignition timing of the ignition part when it is determined that the retard condition is satisfied.

### BRIEF DESCRIPTION OF THE DRAWINGS

The objects, features, and advantages of the present invention will become clearer from the following description of embodiments in relation to the attached drawings, in which:

FIG. 1 is a diagram schematically showing an overall configuration of an engine to which an internal combustion engine control apparatus according to an embodiment of the invention is applied;

FIG. 2 is a diagram schematically showing a major-part configuration of the engine of FIG. 1;

FIG. 3 a graph indicating an example of characteristics representing a change in a combustion state depending on presence or absence of a retard of an ignition timing;

FIG. 4 is a block diagram showing a major-part configuration of the internal combustion engine control apparatus according to the embodiment of the present invention;

FIG. 5 is a flowchart showing an example of a process performed by a retard condition determination unit of FIG. 4;

FIG. 6 is a flowchart showing an example of a process performed by a plug control unit of FIG. 4;

FIG. 7 is a graph indicating an example of a relationship between the amount of retard of the ignition timing and an emission;

FIG. 8A is a timing chart showing a first example of an operation by the internal combustion engine control apparatus according to the embodiment of the invention;

FIG. 8B is a timing chart showing a second example of an operation by the internal combustion engine control apparatus according to the embodiment of the invention;

FIG. 9 is a timing chart showing a third example of an operation by the internal combustion engine control apparatus according to the embodiment of the invention;

FIG. 10 is a timing chart showing a fourth example of an operation by the internal combustion engine control apparatus according to the embodiment of the invention; and

FIG. 11 is a timing chart showing a fifth example of an operation by the internal combustion engine control apparatus according to the embodiment of the invention.

### DETAILED DESCRIPTION OF THE INVENTION

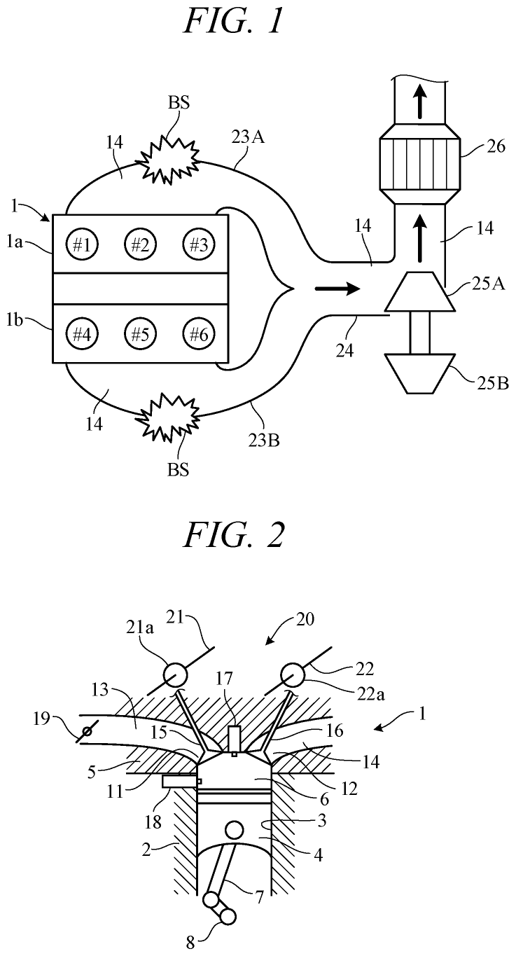

Hereinafter, an embodiment of the present invention will be described with reference to FIGS. 1 to 11. An internal combustion engine control apparatus according to an embodiment of the present invention is applied to an internal combustion engine including a fuel supply part configured to supply a fuel into a combustion chamber in a cylinder and an ignition part configured to ignite a mixture containing the fuel supplied into the combustion chamber, i.e., various types of a spark-ignition internal-combustion engine.

The following explains an example applied to an engine having a fuel cut function for stopping fuel supply to the combustion chamber during deceleration running or the like of a vehicle. The engine is, for example, V-6 engine, in which multiple cylinders are disposed in a V-shape in a side view and a pair of front and rear banks are formed, and four-stroke engine, in which four strokes consisting of intake, compression, combustion, and exhaust are performed in one operation cycle. The engine may be V-type engine in which a pair of left and right banks are formed.

FIG. 1 is a diagram showing the positions of multiple (six) cylinders #1 to #6 of an engine 1. The engine includes three cylinders #1 to #3 in the bank on the front side (front bank) 1a and three cylinders #4 to #6 in the bank on the rear side (rear bank) 1b. Hereafter, the three cylinders #1 to #3 belonging to the front bank 1a may be referred to as front bank cylinder, and the three cylinders #4 to #6 belonging to the rear bank 1b may be referred to as rear bank cylinder. The cylinders #1 to #6 have the same configuration with each other.

FIG. 2 is a diagram schematically showing a major-part configuration of the engine 1. FIG. 2 shows the configuration of one of the cylinders #1 to #6. As shown in FIG. 2, the engine 1 includes a cylinder 3 formed in a cylinder block 2, a piston 4 slidably disposed inside the cylinder 3, and a combustion chamber 6 formed between the piston 4 and a cylinder head 5. The piston 4 is coupled to a crankshaft 8 through a connecting rod 7. The crankshaft 8 rotates by reciprocation of the piston 4 along the inner wall of the cylinder 3.

The cylinder head 5 is provided with an intake port 11 and an exhaust port 12. An intake passage 13 communicates with the combustion chamber 6 through the intake port 11, and an exhaust passage 14 communicates with the combustion chamber 6 through the exhaust port 12. The intake port 11 is opened and closed by an intake valve 15, and the exhaust port 12 is opened and closed by an exhaust valve 16. A throttle valve 19 is disposed upstream of the intake valve 15 on the intake passage 13. The throttle valve 19 is, for example, a butterfly valve and is used to control the amount of intake air flowing into the combustion chamber 6. The throttle valve 19 opens and closes in accordance with a depression operation on an accelerator pedal by a driver. The intake valve 15 and exhaust valve 16 are open and close driven by a valve mechanism 20.

A spark plug 17 and a direct-injection injector 18 are mounted on the cylinder head 5 and cylinder block 2, respectively, so as to face the combustion chamber 6. The spark plug 17 is disposed between the intake port 11 and exhaust port 12 and generates a spark by electrical energy to ignite a mixture of the fuel and air in the combustion chamber 6. The injector 18 is disposed near the intake valve 15 and driven by electrical energy to inject the fuel into the combustion chamber 6 obliquely downward. The injector 18 need not be disposed near the intake valve 15 and may be disposed near the spark plug 17.

The valve mechanism 20 includes an intake camshaft 21 and an exhaust camshaft 22. The intake camshaft 21 is integrally provided with an intake cam 21a corresponding to each cylinder (cylinder 3), and the exhaust camshaft 22 is integrally provided with an exhaust cam 22a corresponding to each cylinder. The intake camshaft 21 and exhaust camshaft 22 are coupled to the crankshaft 8 through a timing belt (not shown) so as to rotate once each time the crankshaft 8 rotates twice. The intake valve 15 is opened and closed by rotation of the intake camshaft 21 through an intake rocker arm (not shown) at a predetermined timing corresponding to the profile of the intake cam 21a. The exhaust valve 16 is opened and closed by rotation of the exhaust camshaft 22 through an exhaust rocker arm (not shown) at a predetermined timing corresponding to the profile of the exhaust cam 22a.

The output torque of the engine 1, that is, the torque generated by rotation of the crankshaft 8 is inputted to a transmission (not shown). The transmission is a stepped transmission, which is able to change the speed ratio in stages so as to correspond to multiple shift positions (e.g., six positions). The transmission may be a continuously variable transmission (CVT), which is able to change the speed ratio continuously. Rotation from the engine 1 is speed-changed by the transmission and then transmitted to the drive wheels. Thus, the vehicle travels. The transmission is an automatic transmission that automatically changes the shift according to the vehicle speed and the required driving force according to the predetermined transmission characteristics. This transmission, by the operation of a shift command part provided in the vicinity or the like of the steering wheel, it is configured to be able to arbitrarily perform the upshift and downshift.

As shown in FIG. 1, a pair of front and rear exhaust manifold 23A and 23B are connected to the engine 1, respectively. An exhaust pipe 24 is connected to the end of the exhaust manifold 23A and 23B. The exhaust passages 14 of the front bank cylinders #1 to #3 and the exhaust passages 14 of the rear bank cylinders #4 to #6 respectively join the exhaust passages 14 in the exhaust pipe 24 via the exhaust manifolds 23A and 23B. FIG. 1 shows a flow of the exhaust gas in the exhaust passage 14 by arrows.

In the exhaust pipe 24, an exhaust turbine 25A which rotates by the exhaust gas flowing through the exhaust passage 14 is disposed. A compressor 25B is coupled to the exhaust turbine 25A coaxially with the exhaust turbine 25A. The exhaust turbine 25A and the compressor 25B rotate integrally, which constitute the turbocharger. The compressor 25B is disposed upstream of the throttle valve 19 of the intake passage 13, the intake air compressed by the rotation of the compressor 25B is supplied into the cylinder 3 of FIG. 2 through an intercooler (not shown).

A catalyst device (an exhaust catalyst device) 26 for cleaning up exhaust gas is disposed in the exhaust passage 14 in the downstream of the exhaust turbine 25A. The catalyst device 26 is a three-way catalyst having a function of eliminating and cleaning up HC, CO, and NOx included in the exhaust gas by oxidation and reduction. Other catalyst devices may also be used, such as an oxidation catalyst which performs oxidation of CO and HC in the exhaust gas. When the temperature of the catalyst contained in the catalyst device 26 increases, the catalyst is activated, and the purification action of the exhaust gas by the catalyst device 26 increases.

The rear bank cylinder #4 to #6 among the plurality of cylinder #1 to #6 are inactive cylinders in which the operation is suspended by stopping the fuel supply from the injector 18 when the predetermined fuel-cut condition is satisfied, and the front bank cylinder #1 to #3 are active cylinders in which the fuel cut is not performed. Not only the rear bank cylinders #4 to #6 but also the front bank cylinders Meanwhile, in order to enhance comfort of a driver while the vehicle is traveling, particularly, comfort of a driver who prefers sporty travel, there is a demand for generating exhaust sound (for example, combustion sound) of the engine 1 at a predetermined timing. In response to the demand, for example, if a pseudo exhaust sound of the engine 1 is generated from a speaker with which the vehicle is equipped, due to the difference between the pseudo exhaust sound and the actual exhaust sound, the driver may feel discomfort leading to insufficient comfort. In particular, it is difficult to generate combustion sound due to combustion of a mixture in a pseudo manner without discomfort. Therefore, in order to satisfy the driver's demand, it is preferable to actually generate desired exhaust sound from the engine 1 by control of the engine 1.

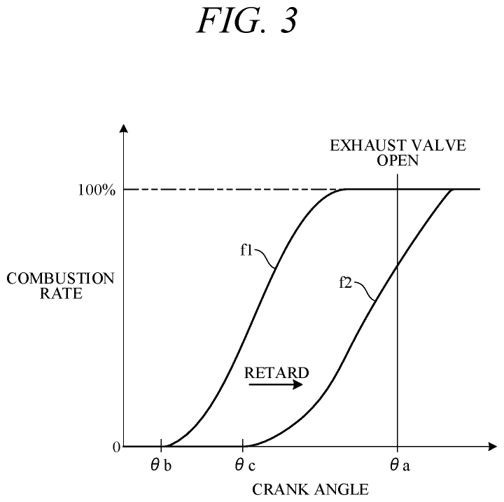

In consideration of this point, in the present embodiment, in response to a command of deceleration traveling of the vehicle such as turning off the accelerator pedal, the ignition timing by the spark plug 17 is delayed (retarded) to cause afterburning of the mixture in the exhaust manifolds 23A, 23B and the exhaust pipe 24 to be performed. FIG. 3 is a graph indicating exemplary characteristics representing a change in the combustion state depending on that retard is performed or not performed at the ignition timing. In the figure, the horizontal axis represents the crank angle and the vertical axis represents the combustion ratio of the mixture. The characteristic f1 in the figure is a characteristic in a case that retard is not performed at the ignition timing, and the characteristic f2 is a characteristic in a case that retard is performed at the ignition timing.

As indicated in the characteristic f1 of FIG. 3, in the case that retard is not performed, the mixture is ignited at the crank angle θb, and the combustion is completed in the combustion chamber 6 before the crank angle θa at which the exhaust valve 16 opens. Thus, no combustion sound is generated in, for example, the exhaust manifolds 23A and 23B due to no afterburning of the mixture. In contrast, as indicated by the characteristic f2, when the ignition timing is retarded and the mixture is ignited at the crank angle θc, combustion is not completed in the combustion chamber 6 before the exhaust valve 16 is opened. Thus, the combustion continues in the exhaust manifolds 23A, 23B and the exhaust pipe 24 beyond the crank angle θa. As a result, afterburning is performed and combustion sound (BS in FIG. 1) is generated.

Retarding the ignition timing and opening the exhaust valve 16 before completion of combustion in the combustion chamber 6 as described above promote afterburning, so that combustion sound is generated. Thus, comfort of a driver is improved. However, retarding the ignition timing may lead to a risk such as damage to the components of the engine 1, occurrence of engine stall, and deterioration in emission. Therefore, in the present embodiment, in order to obtain a desired combustion sound while preventing, for example, damage to the components of the engine 1, and occurrence of engine stall, the internal combustion engine control apparatus is configured as below.

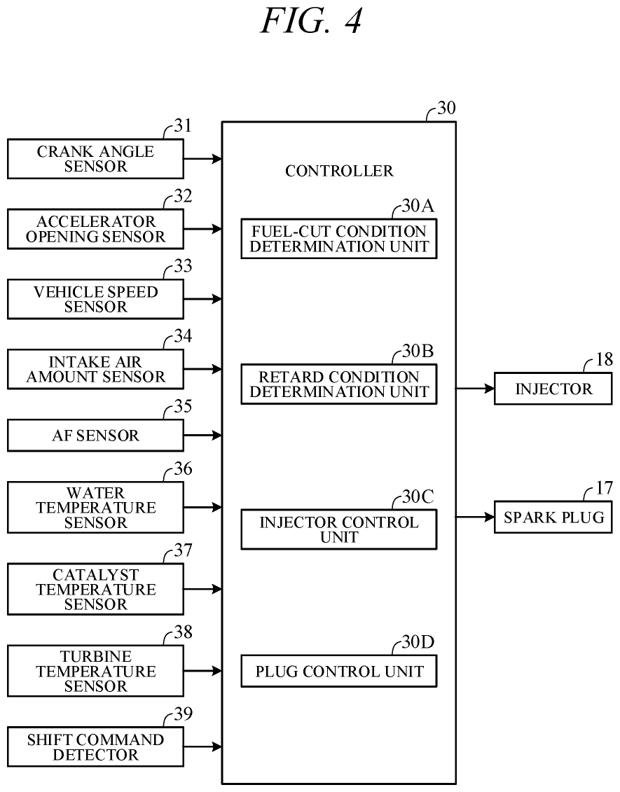

FIG. 4 is a block diagram showing a major-part configuration of an internal combustion engine control apparatus according to the embodiment of the present invention. As shown in FIG. 4, the internal combustion engine control apparatus is configured centered on a controller 30 for engine control. A crank angle sensor 31, an accelerator opening sensor 32, a vehicle speed sensor 33, an intake air amount sensor 34, an AF sensor 35, a water temperature sensor 36, a catalyst temperature sensor 37, a turbine temperature sensor 38, a shift command detector 39, and the injectors 18 and spark plug 17 provided in each of the cylinders #1 to #6 are connected to the controller 30.

The crank angle sensor 31 is disposed on the crankshaft 8 and is configured to output a pulse signal in response to rotation of the crankshaft 8. The controller 30 identifies the rotation angle of the crankshaft 8 (crank angle) with respect to the position of the top dead center (TDC) of the piston 4 at the start of the intake stroke and calculates the engine rotational speed on the basis of pulse signals from the crank angle sensor 31. The accelerator opening sensor 32 is disposed on the acceleration pedal (not shown) of the vehicle and detects an amount of depression operation of the acceleration pedal (accelerator opening). A command indicating the target torque of the engine 1 is issued on the basis of the value detected by the accelerator opening sensor 32.

The vehicle speed sensor 33 detects a vehicle speed. The intake air amount sensor 34 detects an amount of intake air and is configured by, for example, an airflow meter disposed in the intake passage 13. The AF sensor 35 is disposed in the exhaust passage 14 upstream of the catalyst device 26 and detects the air-fuel ratio of exhaust gas in the exhaust passage 14.

The water temperature sensor 36 is disposed on a passage through which engine cooling water for cooling the engine 1 flows and detects the temperature of the engine cooling water (cooling water temperature). The cooling water temperature and the temperature of the engine 1 have a correlation with each other. Therefore, the temperature of the engine 1 can be detected (estimated) based on the value detected by the water temperature sensor 36. The temperature of the engine 1 may be detected by a temperature sensor attached to the engine body.

The catalyst temperature sensor 37 is disposed on the catalyst device 26 and detects the temperature (catalyst temperature) of the catalyst device 26. In consideration of the point at which the catalyst is activated when the catalyst temperature increases, the catalyst temperature may be detected (estimated) by the AF sensor 35. The catalyst temperature may be detected (estimated) based on other physical amount having a correlation with the catalyst temperature. The turbine temperature sensor 38 is disposed on a case or the like in the vicinity of the exhaust turbine 25A and detects the temperature of the exhaust turbine 25A. The turbine temperature may be detected (estimated) based on other physical amount having a correlation with the turbine temperature.

The shift command detector 39 detects input of a downshift command and an upshift command by the operation of the shift command part provided in the vicinity of the steering wheel. When the upshift command is input, the transmission is controlled so that the shift stage increases (upshifts). This reduces the speed ratio and reduces the engine torque. On the other hand, when the downshift command is input, the transmission is controlled so that the shift stage decreases (downshifts). This increases the speed ratio and increases the engine torque. That is, the upshift command corresponds to a request command for torque down, and the downshift command corresponds to a request command for torque up.

The controller 30 consists of an electronic control unit (ECU) and includes a computer including an arithmetic processing unit, such as a CPU (microprocessor), a storage unit (memory), such as a ROM or RAM, and other peripheral circuits. The controller 30 includes, as functional elements, a fuel-cut condition determination unit 30A, a retard condition determination unit 30B, an injector control unit 30C and a plug control unit 30D.

The fuel-cut condition determination unit 30A determines whether or not the fuel-cut condition is satisfied, on the basis of signals from the crank angle sensor 31, the accelerator opening sensor 32, and the vehicle speed sensor 33. The fuel-cut condition is satisfied, for example, in predetermined deceleration traveling. Specifically, the fuel-cut condition is established when the accelerator opening detected by the accelerator opening sensor 32 is not more than a predetermined value, the engine rotational speed detected by the crank angle sensor 31 is not less than a predetermined value, and the vehicle speed detected by the vehicle speed sensor 33 is not less than a predetermined value. The fuel-cut condition determination unit 30A turns on a fuel-cut flag in a case where the fuel-cut condition is satisfied, turns off the fuel-cut flag when the fuel-cut condition is not satisfied.

The retard condition determination unit 30B determines whether or not the ignition-timing retard condition is established, on the basis of signals from the crank angle sensor 31, the accelerator opening sensor 32, the intake air amount sensor 34, the water temperature sensor 36, the catalyst temperature sensor 37, and the turbine temperature sensor 38. The ignition-timing retard condition is a condition as a premise for retarding the ignition timing in order to generate combustion sound due to afterburning of the mixture.

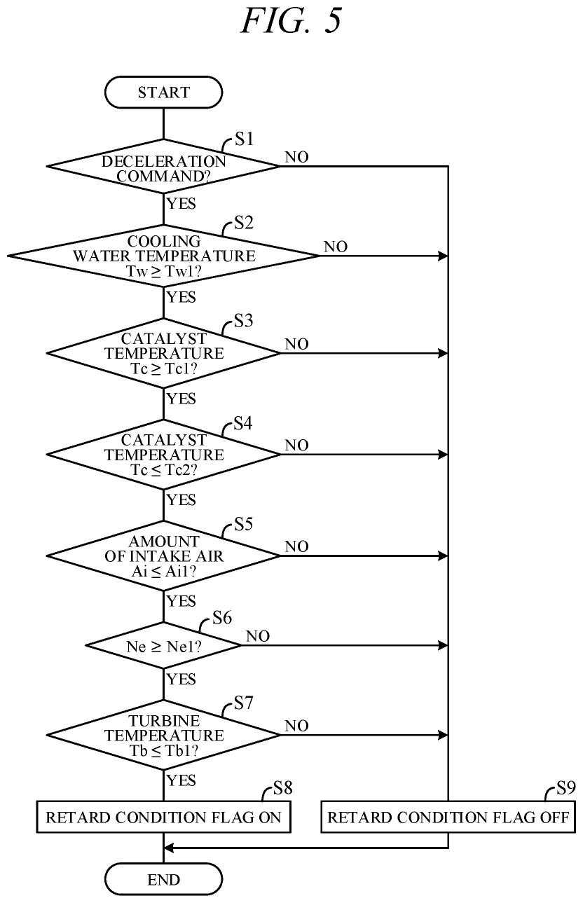

FIG. 5 is a flowchart showing an example of a process performed by the retard condition determination unit 30B. The process shown in the flowchart starts, for example, with turning on the engine switch, and repeats at predetermined cycles.

As shown in FIG. 5, first, in S1 (S: process step), it is determined whether or not a predetermined deceleration command is output during traveling of the vehicle, on the basis of signal from the accelerator opening sensor 32. This determination is, for example, a determination as to whether or not the accelerator pedal is turned off (not operated). A determination may be made whether or not the amount of depression operation of the accelerator pedal is not more than a predetermined value. The deceleration command corresponds to a torque-down command for the engine 1.

In a case where the result of the determination in S1 is YES, the process goes to S2, and it is determined whether or not the cooling water temperature Tw of the engine 1 detected by the water temperature sensor 36 is not lower than a predetermined value Tw1. This determination is a determination as to whether or not warm-up of the engine 1 is completed. That is, the emission is likely to deteriorate before warm-up of the engine 1 is completed, and thus it needs to suppress retard of the ignition timing. In consideration of this point, the predetermined value Tw1 is set in advance at a value that, for example, enables prevention of deterioration in emission even if the ignition timing is retarded.

In a case where the result of the determination in S2 is YES, the process goes to S3, and it is determined whether or not the catalyst temperature Tc detected by the catalyst temperature sensor 37 is not lower than a predetermined value Tc1. This determination is a determination as to whether or not warm-up operation of the catalyst device 26 is completed. That is, the cleaning effect on the exhaust gas by the catalyst is low before warm-up of the catalyst device 26 is completed. Thus, it needs to suppress retard of the ignition timing, for example, that leads to deterioration in emission. In consideration of this point, the predetermined value Tc1 is set in advance at a value that, for example, enables the catalyst to be activated and to enhance its cleaning effect on the exhaust gas.

In a case where the result of the determination in S3 is YES, the process goes to S4. In S4, it is determined whether or not the catalyst temperature Tc detected by the catalyst temperature sensor 37 is not higher than a predetermined value Tc2. This determination is a determination as to whether or not the catalyst device 26 is likely to be damaged in a case where the exhaust temperature rises due to retard of the ignition timing. The predetermined value Tc2 is set in advance at a value that, for example, enables reliable prevention of damage to the catalyst in a case where the ignition timing is retarded, in consideration of a transient rise in the exhaust temperature. The predetermined value Tc2 is higher than the predetermined value Tc1.

In a case where the result of the determination in S4 is YES, the process goes to S5, and it is determined whether or not the amount of intake air Ai detected by the intake air amount sensor 34 is not more than a predetermined value Ai1. This determination is a determination as to whether or not the components of the exhaust system is likely to be damaged in a case where the exhaust temperature rises due to retard of the ignition timing. That is, when the amount of intake air increases, the exhaust temperature rises easily, and thus it needs to suppress retard of the ignition timing at which, for example, the exhaust temperature rises excessively. In consideration of this point, the predetermined value Ai1 is set in advance at a value that, for example, enables prevention of damage to the components of the exhaust system in a case where the ignition timing is retarded.

In a case where the result of the determination in S5 is YES, the process goes to S6, and it is determined whether or not the engine rotational speed Ne detected by the crank angle sensor 31 is not less than a predetermined value Ne1. This determination is a determination as to whether or not engine stall occurs due to retard of the ignition timing. That is, retarding the ignition timing leads to an unstable combustion state, and thus when the engine rotational speed is small, engine stall may occur. In consideration of this point, the predetermined value Ne1 is set in advance at a value with which, for example, no engine stall occurs even if the ignition timing is retarded. For example, the predetermined value Ne1 is set in advance at a threshold of the engine rotational speed for determination whether or not the fuel-cut condition is satisfied.

In a case where the result of the determination in S6 is YES, the process goes to S7, and it is determined whether or not the turbine temperature Tb detected by the turbine temperature sensor 38 is not higher than a predetermined value Tb1. This determination is a determination as to whether or not the exhaust turbine 25A is likely to be damaged in a case where the exhaust temperature rises due to retard of the ignition timing. The predetermined value Tb1 is set in advance at a value that, for example, enables reliably prevention of damage to the exhaust turbine 25A in a case where the ignition timing is retarded, in consideration of a transient rise in the exhaust temperature.

In a case where the result of the determination in S7 is YES, the process goes to S8, it is determined that the ignition-timing retard condition is established, and the retard condition flag is turned on. Otherwise, in a case where the result of the determination in any of S1 to S7 is NO, the process goes to S9, it is determined that the ignition-timing retard condition is not established, and the retard condition flag is turned off.

The injector control unit 30C in FIG. 4 calculates the target amount of injection on the basis of signals from the intake air amount sensor 34 and the AF sensor 35 such that the mixture in the combustion chamber 6 of each of the cylinders #1 to #6 is the target air-fuel ratio (for example, theoretical air-fuel ratio) before the fuel is cut off. Then, the injector 18 of each of the cylinders #1 to #6 is controlled such that the amount of fuel corresponding to the target amount of injection is injected at a predetermined timing. For example, each injector 18 is controlled such that one injection (single intake) or a plurality of injections (multiple intake stages) in the intake stroke is performed, one injection (single compression) or a plurality of injections (multiple compression stages) in the compression stroke is performed, or predetermined injections (multiple intake-compression stages) in each of the intake stroke and the compression stroke are performed.

When the fuel-cut flag output from the fuel-cut condition determination unit 30A is turned on, the injector control unit 30C controls the injectors 18 of the rear bank cylinders (inactive cylinders) #4 to #6 such that the fuel is cut. In this case, first, the ignition timing is retarded by the plug control unit 30D, and when the retard of the ignition timing is completed, the injector control unit 30C cuts the fuel. As a result, shock at the time of the fuel cut is reduced. At the time of the fuel cut, the injectors 18 of the front bank cylinders (active cylinders) #1 to #3 are controlled such that fuel is injected by the target amount of injection according to the amount of intake air. The injectors 18 of the front bank cylinders #1 to #3 may be controlled such that the fuel is cut, similarly to the injectors 18 of the rear bank cylinders #4 to #6. In order to reduce shock due to a rapid decrease in torque resulting from fuel cut, the fuel cut is sequentially performed for the plurality of cylinders.

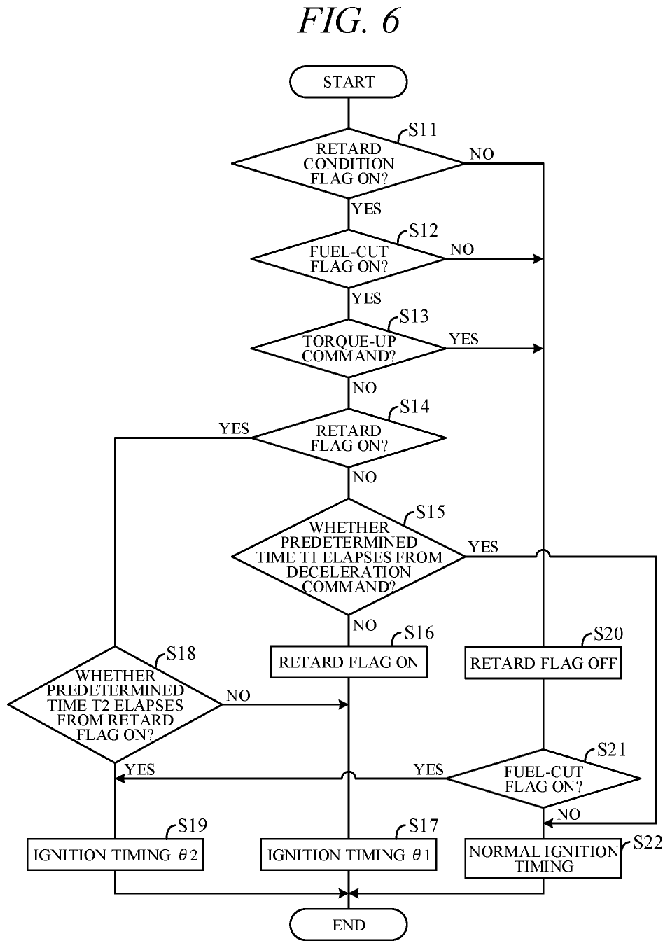

In accordance with the determination results of the fuel-cut condition determination unit 30A and the retard condition determination unit 30B, the plug control unit 30D controls each spark plug 17 such that the ignition timing of each spark plug 17 is a predetermined ignition timing. FIG. 6 is a flowchart showing an example of a process performed by the plug control unit 30D, particularly, an exemplary process related to the ignition timing of the spark plugs 17 of the rear bank cylinders #4 to #6 (inactive cylinders). The process shown in the flowchart starts, for example, with turning on the engine switch, and repeats at predetermined cycles.

As shown in FIG. 6, first, in S11, it is determined whether or not the retard condition flag output from the retard condition determination unit 30B is on. In a case where the result of the determination in S11 is YES, the process goes to S12, and it is determined whether the fuel-cut flag output from the fuel-cut condition determination unit 30A is on. In a case where the result of the determination in S12 is YES, the process goes to S13, and on the basis of signal from the shift command detector 39, it is determined whether or not a torque-up command is input. That is, it is determined whether or not a command of downshifting is made by operation of the shift command part.

In a case where the result of the determination in either S11 or S12 is NO, or in a case where the result of the determination in S13 is YES, the process proceeds to S20 and the retard flag is turned off. Note that the retard flag is a flag that is turned on at the start of retarding the ignition timing for generating combustion sound due to afterburning of the mixture. Next, in S21, it is determined whether or not the fuel-cut flag is on. In a case where the result of determination in S21 is YES, the process goes to S19; otherwise, the process goes to S22. In S22, a control signal is output to the spark plug 17 of interest such that the ignition timing is a predetermined ignition timing (normal ignition timing) stored in advance, for example, the optimum ignition timing θ0 at which the maximum torque is obtained. The optimum ignition timing θ0 corresponds to the crank angle θb in FIG. 3.

On the other hand, in a case where the result of the determination in S13 is NO, the process goes to S14, and it is determined whether or not the retard flag is on. In a case where the result of the determination in S14 is NO, the process goes to S15. In S15, it is determined whether or not a predetermined time period T1 stored in advance elapses after it is determined in Si that the deceleration command (torque-down command) has been input. The predetermined time period T1 is an allowable time period from the input of the deceleration command (torque-down command) by the driver to the start of combustion (afterburning) of the mixture in the exhaust manifolds 23A and 23B by retarding the ignition timing. When the time interval between the input time point of the deceleration command and the start time point of afterburning in the exhaust manifolds 23A and 23B is long, the driver feels discomfort about the combustion sound, and thus the predetermined time period T1 is set at a time (for example, about 1 second) during which the driver does not feel discomfort.

In a case where the result of determination in S15 is YES, the process goes to S22; otherwise, the process goes to S16. In S16, the retard flag is turned on. Next, in S17, a control signal is output to the spark plugs 17, the ignition timing θ is gradually delayed to a predetermined value θ1 stored in advance, and when the ignition timing θ reaches the predetermined value θ1, the ignition timing is maintained at the predetermined value θ1. The predetermined value θ1 is an ignition timing at which combustion sound due to afterburning of the mixture can be generated. Thus, the combustion sound can be generated in the exhaust manifolds 23A, 23B and the exhaust pipe 24.

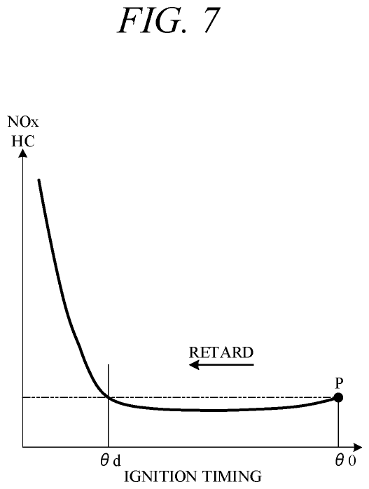

FIG. 7 is a graph indicating an example of a relationship between the amount of retard of the ignition timing and an emission. As indicated in FIG. 7, the point P is a normal operation point (the optimum ignition timing θ0). As the amount of retard at the ignition timing is larger, combustion sound due to afterburning is more likely to be generated. However, as indicated in FIG. 7, when the ignition timing is retarded from the operation point P and the amount of retard at the ignition timing exceeds θd, combustion becomes unstable that leads to deterioration in emission. In consideration of this point, the predetermined value θ1 is set at, for example, θd in FIG. 7. θd corresponds to, for example, the crank angle θc in FIG. 3.

In a case where the result of the determination in S14 of FIG. 6 is YES, the process goes to S18. In S18, it is determined whether or not a predetermined time period T2 stored in advance elapses after the retard flag has been turned on in S16. The predetermined time period T2 is a duration of the combustion sound due to afterburning. If this duration is short, the driver may not notice that the combustion sound is generated. In contrast, if the duration is long, the driver may feel the combustion sound as abnormal noise. In consideration of this point, the predetermined time period T2 is set within a range of 0.3 to 0.5 seconds, for example.

In a case where the result of the determination in S18 is YES, the process goes to S19; otherwise, the process goes to S17. In S19, a control signal is output to the spark plug 17 of interest, the ignition timing θ is gradually delayed to the predetermined value θ2 stored in advance, and when the ignition timing θ reaches the predetermined value θ2, the ignition timing is maintained at the predetermined value θ2. The predetermined value θ2 is larger in amount of retard than the predetermined value θ1, and the fuel cut is performed by the injector control unit 30C after the ignition timing reaches the predetermined value θ2.

Thereafter, a fuel-cut process (not shown) is executed. During the execution of the fuel-cut process, the ignition timing is maintained at the predetermined value θ2. When the ignition timing is changed in S19, the retard condition flag is turned off with the retard flag turned on. That is, in this case, there is no need to generate combustion sound due to afterburning, and thus the retard condition flag as a premise for combustion sound generation is turned off.

Although not shown, in a case where the spark plugs 17 of the front bank cylinders #1 to #3 as active cylinders are controlled, the process of S19 in FIG. 6 is omitted, and in a case where the result of the determination in S18 is YES, the process goes to S20 and the retard flag is turned off. Further, in S22, a control signal is output to the spark plug 17 of interest such that the ignition timing gradually reaches the optimum ignition timing θ0. In a case where the front bank cylinders #1 to #3 each serve as an inactive cylinder, the spark plugs 17 of the front bank cylinders #1 to #3 are controlled in ignition timing, similarly to FIG. 6.

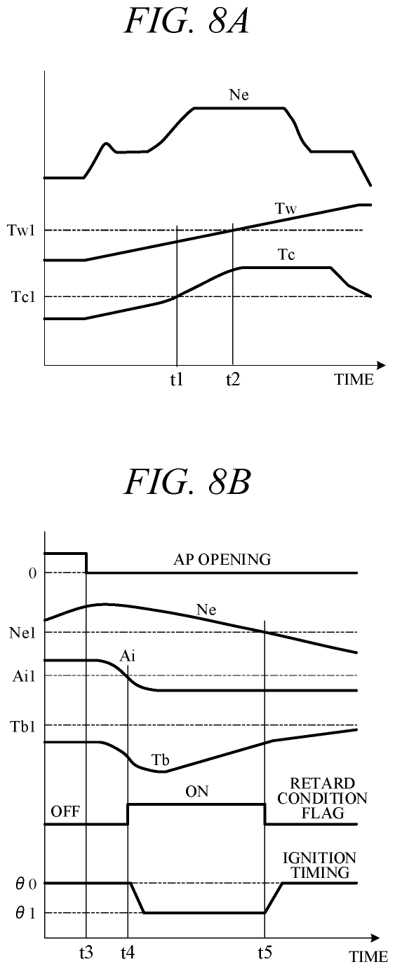

The operation of the internal combustion engine control apparatus according to the present embodiment will be described more specifically. FIG. 8A is a timing chart showing an example of change, with an elapse of time, in the engine rotational speed Ne, the engine cooling water temperature Tw, and the catalyst temperature Tc, and particularly indicating a situation at the time of starting the engine 1. As illustrated in FIG. 8A, when the engine 1 starts, the engine cooling water temperature Tw and the catalyst temperature Tc both rise, the catalyst temperature Tc becomes not lower than the predetermined value Tc1 at the time point t1, and the engine cooling water temperature Tw becomes not lower than the predetermined value Tw1 at the time point t2. As a result, part of the retard condition of the ignition timing is satisfied (S2, S3).

FIG. 8B is a timing chart showing an example of change, with an elapse of time, in the opening of the accelerator pedal (AP opening), the engine rotational speed Ne, the amount of intake air Ai, the turbine temperature Tb, the retard condition flag, and the ignition timing. Note that the ignition timing is an ignition timing for the front bank cylinders #1 to #3 (active cylinders). Although not shown, it is assumed that the engine cooling water temperature Tw is not lower than the predetermined value Tw1, and the catalyst temperature Tc is not lower than the predetermined value Tc1 and not higher than the predetermined value Tc2.

The timing chart of FIG. 8B starts with a state in which the engine rotational speed Ne is not less than the predetermined value Ne1, the amount of intake air Ai is larger than the predetermined value Ai1, and the turbine temperature Tb is not higher than the predetermined value Tb1. At this time, after the accelerator opening becomes 0 (pedal non-operation) at a time point t3, when the amount of intake air Ai becomes not more than the predetermined value Ai1 at a time point t4, the retard condition flag is turned on (S1 to S8). The time period from the time point t3 to the time point t4 is less than the predetermined time period T1, and thus the ignition timing is gradually retarded from the optimum ignition timing θ0 to the predetermined value θ1. As a result, combustion sound is generated in, for example, the exhaust manifolds 23A, 23B and the exhaust pipe 24 due to afterburning of the mixture.

Thereafter, when the engine rotational speed Ne becomes less than the predetermined value Ne1 at the time point t5 before the predetermined time period T2 elapses from the time point t4, the retard condition flag is turned off (S9). As a result, the retard of the ignition timing ends, and the ignition timing gradually returns to the optimum ignition timing θ0.

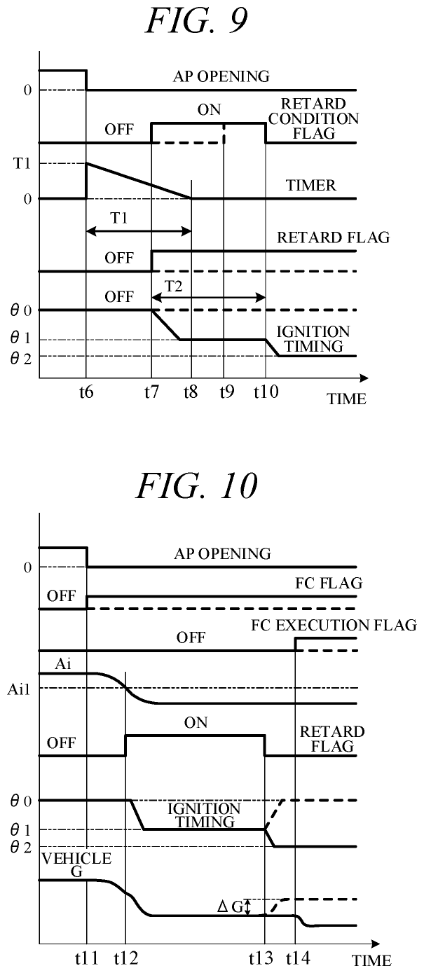

FIG. 9 is a timing chart showing an example of change, with an elapse of time, in the opening of the accelerator pedal (AP opening), the retard condition flag, a timer, the retard flag (FIG. 6), and the ignition timing. Note that the timer counts the predetermined time period T1 starting from a time point at which the AP opening becomes 0. The ignition timing is an ignition timing for the rear bank cylinders #4 to #6 (inactive cylinders).

As shown in FIG. 9, when the accelerator opening becomes 0 at a time point t6, the timer starts counting, and the predetermined time period T1 elapses at a time point t8. At this time, when the retard condition flag is turned on at a time point t7 before the time point t8 as indicated by a solid line, the retard flag is turned on and the ignition timing is gradually retarded to the predetermined value θ1 (S16, S17). Thereafter, at a time point t10, when the predetermined time period T2 elapses from the start of retarding the ignition timing, the ignition timing is gradually retarded to the predetermined value θ2 (S19).

However, as indicated by a dotted line in FIG. 9, when the retard condition flag is turned on at a time point t9 after the time point t8, the retard flag remains off. In this case, the ignition timing is not retarded but controlled to the optimum ignition timing θ0 (S15→S22).

FIG. 10 is a timing chart showing an example of change in, with an elapse of time, the opening of the accelerator pedal (AP opening), the fuel-cut flag (FC flag), a fuel-cut execution flag (FC execution flag), the amount of intake air Ai, the retard flag, the ignition timing, and the driving force of the vehicle (vehicle G). Note that the fuel-cut execution flag is a flag for instructing the injector control unit 30C to perform fuel cut, and when the fuel-cut execution flag is turned on, the fuel cut is performed.

As shown in FIG. 10, after the accelerator opening becomes 0, the fuel-cut condition is satisfied, and the fuel-cut flag is turned on at a time point t11, when the amount of intake air Ai becomes not more than the predetermined value Ai1 and the retard flag is turned on at a time point t12, the ignition timing is gradually retarded to the predetermined value θ1 (S17). At this time, the driving force of the vehicle decreases due to the decrease in the amount of intake air and the retard of the ignition timing. Thereafter, when the retard flag is turned off at a time point t13 (S20), the ignition timing is gradually retarded to the predetermined value θ2 (S21→S19). Further, when the fuel-cut execution flag is turned on at a time point t14, the fuel cut is performed and the driving force of the vehicle decreases.

In contrast, as indicated by a dotted line in FIG. 10, in a case where the retard flag is turned on without the condition that the fuel-cut flag is turned on, the ignition timing returns to the optimum ignition timing θ0 at the time point t13, and the driving force of the vehicle increases. In this case, due to the retard of the ignition timing, the driving force temporarily decreases by ΔG as compared with the ignition timing after returning to the optimum ignition timing θ0, so that the driver is likely to feel discomfort. However, in a case where the ignition timing is retarded with the condition that the fuel-cut flag is turned on as in the present embodiment, the driving force of the vehicle does not increase at the time point t13, and then the driving force decreases due to the fuel cut, so that the driver is less likely to feel discomfort.

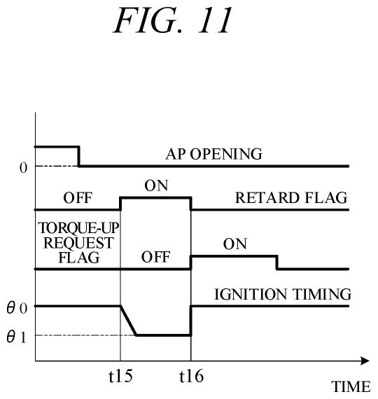

FIG. 11 is a timing chart showing an example of change in, with an elapse of time, the opening of the accelerator pedal (AP opening), the retard flag, a torque-up request flag, and the ignition timing. Note that the torque-up request flag is turned on, for example, in response to a downshift is instructed by operation of the shift command part.

As shown in FIG. 11, when the retard flag is turned on at a time point t15 after the accelerator opening becomes θ, the ignition timing is gradually retarded to the predetermined value θ1. Thereafter, when the torque-up request flag is turned on at a time point t16, the retard flag is turned off and the ignition timing becomes the optimum ignition timing θ0 (S13→S20 and S22). That is, afterburning of the mixture ends without waiting for the elapse of the predetermined time period T2. This enables immediately obtaining a desired engine torque.

According to the present embodiment, following functions and effects can be exerted.

(1) An engine 1 includes an injector 18 that supplies fuel to a combustion chamber 6 in a cylinder 3, and an spark plug 17 that ignites a mixture containing the fuel supplied in the combustion chamber 6 (FIG. 2). An internal combustion engine control apparatus applied to the above engine 1 includes: sensors such as a crank angle sensor 31 that detects a rotational speed Ne of the engine 1, and an intake air amount sensor 34 that detects an amount of intake air Ai supplied to the combustion chamber 6; an accelerator opening sensor 32 that detects a command of deceleration traveling of a vehicle equipped with the engine 1; an injector control unit 30C and a plug control unit 30D that control the injector 18 and the spark plug 17, respectively; a retard condition determination unit 30B determines whether or not a retard condition of an ignition timing is satisfied on the basis of a signal from the crank angle sensor 31 or the intake air amount sensor 34, in response to detection of the command of deceleration traveling of the vehicle by the accelerator opening sensor 32 (FIG. 4). When the retard condition determination unit 30B determines that the retard condition is satisfied (that a retard condition flag is on), the plug control unit 30D controls the spark plug 17 such that ignition-timing retard control of delaying the ignition timing of the spark plug 17 to a predetermined value 01 is performed (FIG. 6).

Thus, the mixture is subjected to afterburning in exhaust manifolds 23A, 23B and an exhaust pipe 24, so that a desired combustion sound comfortable for the driver can be obtained in response to a deceleration command. In addition, an excessively high exhaust temperature can be prevented, and damage to the components of the engine 1 can be prevented. Further, occurrence of engine stall can be prevented in a case where the ignition timing is retarded.

(2) When the engine rotational speed Ne detected by the crank angle sensor 31 is not less than a predetermined value Ne1, the retard condition determination unit 30B determines that the retard condition of the ignition timing is satisfied (FIGS. 5 and 8B). Thus, engine stall can be satisfactorily prevented in a case where combustion sound is generated due to afterburning of the mixture.

(3) When the amount of intake air Ai supplied to the combustion chamber 6 detected by the intake air amount sensor 34 is not more than a predetermined value Ai1, the retard condition determination unit 30B determines that the retard condition of the ignition timing is satisfied (FIGS. 5 and 8B). Thus, an excessively high exhaust temperature can be satisfactorily prevented in a case where combustion sound is generated due to afterburning of the mixture.

(4) The internal combustion engine control apparatus further includes a water temperature sensor 36 that detects a cooling water temperature Tw having a correlation with a temperature of the engine 1 (FIG. 4). The retard condition determination unit 30B determines that the retard condition of the ignition timing is satisfied, with an additional condition that the cooling water temperature Tw detected by the water temperature sensor 36 is not lower than a predetermined value Tw1 (FIGS. 5 and 8A). Thus, the ignition timing is retarded after warm-up of the engine 1, so that deterioration in emission can be suppressed.

(5) The engine 1 further includes a catalyst device 26 that purifies exhaust of the engine 1 (FIG. 1). The internal combustion engine control apparatus further includes a catalyst temperature sensor 37 that detects (estimates) a temperature of the catalyst device 26 (FIG. 4). The retard condition determination unit 30B determines that the retard condition of the ignition timing is satisfied, with an additional condition that a catalyst temperature Tc detected by the catalyst temperature sensor 37 is not lower than a predetermined value Tc1 (FIGS. 5 and 8A). Thus, the ignition timing is retarded after warm-up of the catalyst device 26, so that deterioration in emission can be suppressed.

(6) The plug control unit 30D determines whether or not the retard condition of the ignition timing is satisfied within a predetermined time period T1 after the detection of the command of deceleration traveling of the vehicle by the accelerator opening sensor 32 (whether the retard condition flag is on or off) (FIGS. 6 and 9). Then, when it is determined that the retard condition of the ignition timing is satisfied (the retard condition flag is on) within the predetermined time period T1, the spark plug 17 is controlled to perform the ignition-timing retard control (FIG. 6). Thus, the driver can feel combustion sound without discomfort during deceleration operation.

(7) The engine 1 includes a plurality of cylinders #1 to #6 (FIG. 1). When the retard condition determination unit 30B determines that the retard condition of the ignition timing is satisfied, the plug control unit 30D controls the spark plug 17 such that the ignition-timing retard control (FIG. 6) is performed to each of the plurality of cylinders #1 to #6. Thus, combustion sound can be generated effectively.

(8) Among the plurality of cylinders #1 to #6, the plurality of cylinders #1 to #3 each serve as a front bank cylinder and the plurality of cylinders #4 to #6 each serve as a rear bank cylinder (FIG. 1). Thus, combustion sound can be effectively generated in each of the exhaust manifold 23A in connection with the front bank cylinders #1 to #3 and the exhaust manifold 23B in connection with the rear bank cylinders #4 to #6.

(9) A fuel-cut condition determination unit 30A determines whether or not a fuel-cut condition is satisfied (FIG. 4). When it is determined that the fuel-cut condition is satisfied, the injector control unit 30C controls the injector 18 such that fuel cut is performed to each of the rear bank cylinders #4 to #6 but no fuel cut is performed to each of the front bank cylinders #1 to #3. Thus, the ignition-timing retard control can be satisfactorily performed in combination with the fuel cut.

(10) When the retard condition determination unit 30B determines that the retard condition of the ignition timing is satisfied and the fuel-cut condition determination unit 30A determines that the fuel-cut condition is satisfied, the plug control unit 30D and the injector control unit 30C control, respectively, the spark plug 17 and the controls the injector 18 such that the fuel cut is performed after ignition-timing retard control is performed (FIGS. 6 and 10). As above, the ignition-timing retard control is performed with the condition that the fuel cut is performed, so that the driver is less likely to feel discomfort at the time of torque down due to the ignition-timing retard control. Therefore, combustion sound can be generated without discomfort.

(11) The accelerator opening sensor 32 that detects an opening of an accelerator pedal operated by a driver detects the command of deceleration traveling that is part of the retard condition. Thus, combustion sound can be generated at the optimum timing in response to the deceleration operation by the driver.

(12) When the retard condition determination unit 30B determines that the retard condition of the ignition timing is satisfied, the plug control unit 30D controls the spark plug 17 such that the ignition-timing retard control is continuously performed for a predetermined time period T2 (FIGS. 6 and 9). Thus, the driver feels combustion sound more easily.

(13) The internal-combustion-engine control apparatus further includes a shift command detector 39 that detects input of a torque-up command (FIG. 4). In response to detection, by the shift command detector 39, of the input of the torque-up command before the predetermined time period T2 elapses from start of the ignition-timing retard control, the plug control unit 30D controls the spark plug 17 such that ignition-timing retard control is canceled (FIGS. 6 and 11). Thus, the engine torque can immediately rise in response to a torque-up request.

Various modifications of the above embodiment are possible. Some examples are explained in the following. In the above embodiment, when it is determined that the retard condition of the ignition timing is satisfied, the ignition-timing retard control is performed for each of the cylinders #1 to #6. However, the ignition-timing retard control may be performed for the rear bank cylinders (inactive cylinders) #4 to #6 in which the fuel cut are performed, and the ignition-timing retard control may be not performed for the front bank cylinders (active cylinders) #1 to #3 in which the fuel cut are not performed. Therefore, part of cylinders #4 to #6 among the plurality of cylinders #1 to #6 can be used as cylinders for generating combustion sound in response to the command of deceleration traveling.

In the above embodiment, the injector control unit 30C outputs control signals to the injectors 18 to inject fuel from the injectors 18 at a predetermined timing, but in all or part of the plurality of cylinders #1 to #6, when the retard control of the ignition timing is executed, the injection start timing of the fuel may be delayed from that before the execution of the retard control. That is, in the case where injection is performed in any of the single-injection in intake, multiple-injection in intake, single-injection in compression, multiple-injection in compression, and multiple-injection in intake and compression, the injection timing may be delayed. When multiple-injection in intake, multiple-injection in compression, and multiple-injection in intake-compression are performed, the injection timing in at least one of the plurality of injections may be delayed. When fuel is injected in the compression stroke prior to the execution of the retard control of the ignition timing, the injection timing of the fuel may be changed from the compression stroke to the exhaust stroke during performing the retarded control.

Although in the above embodiment, the injector 18 is disposed facing the combustion chamber 6, the configuration of a fuel supply part for supplying fuel into a combustion chamber in a cylinder is not limited thereto. The configuration of the spark plug 17 as an ignition part for igniting a mixture is not limited to those described above. Although in the above embodiment, the engine rotational speed Ne is detected by the crank angle sensor 31, and the intake air amount Ai supplied to the combustion chamber 6 is detected by the intake air amount sensor 34, the configuration of an acquiring part for acquiring these values is not limited thereto. That is, the configuration of the acquiring part may be any one as long as it acquires a value of at least one of the rotational speed of the internal combustion engine and the amount of intake air supplied to the combustion chamber. The acquiring part may be configured to acquire a value of a physical amount having a correlation with at least one of the rotational speed of the internal combustion engine and the amount of intake air supplied to the combustion chamber.

Although in the above embodiment, a command for deceleration traveling of the vehicle or torque down of the engine 1 is detected by the accelerator opening sensor 32, a command detector is not limited to the above configuration. That is, as long as a command of a deceleration or a command of a decrease of a torque (torque down) is detected by detecting an operation of an input part by a driver to input a required driving force for the vehicle, an operation of another input part may be detected. By detecting a speed change command to the transmission for shifting and outputting a rotation input via the output shaft of the internal combustion engine, i.e. by detecting the operation of the downshift, it may be detected the command of torque down or deceleration.

In the above embodiment, when a command for deceleration traveling or torque down of the vehicle is detected by the accelerator opening sensor 32, the retard condition determination unit 30B determines whether or not the retard condition of the ignition timing is satisfied based on the value detected (acquired) by a detecting part (acquiring part) such as the crank angle sensor 31 (a rotational speed sensor), the intake air amount sensor 34, the water temperature sensor 36, and the catalyst temperature sensor 37, but the configuration of a determination unit is not limited thereto. That is, as long as whether the retard condition of the ignition timing is satisfied, is determined based on the detection value of at least one of the rotational speed of the internal combustion engine and the amount of intake air supplied to the combustion chamber, the configuration of the determination unit may be any. In the above embodiment, the plug control unit 30D determines whether or not the retard condition of the ignition timing is satisfied within the predetermined time period T1 after the command of deceleration traveling or torque down is detected, but this is also included in the determination of the determination unit. Although in the above embodiment, the fuel-cut condition determination unit 30A determines whether or not the fuel-cut condition is satisfied, this is also included in the determination of the determination unit.

Although in the above embodiment, the engine 1 includes a plurality of rear bank cylinders #4 to #6 (a first group cylinder) and a plurality of front bank cylinders #1 to #3 (a second group cylinder), the configuration of a first cylinder belonging to the first group cylinder and a second cylinder belonging to the second group cylinder is not limited to those described above. In the above embodiment, when it is determined that the fuel-cut condition is satisfied by the fuel-cut condition determination unit 30A, the injector control unit 30C serving as a control unit performs the fuel-cut for the rear bank cylinders #4 to #6 (the first cylinder) without performing the fuel-cut for the front bank cylinders #1 to #3 (the second cylinder). However, the injector control unit 30C may be perform the fuel-cut for the second cylinder without performing the fuel-cut for the first cylinder, or may be perform the fuel-cut for both the first cylinder and the second cylinder.

In the above embodiment, when the retard condition is determined by the retard condition determination unit 30B to be satisfied and the fuel-cut condition is determined by the fuel-cut condition determination unit 30A to be satisfied, the plug control unit 30D serving as the control unit performs the fuel-cut after performing the retard control of the ignition timing. However, the plug control unit 30D may perform the retard control of the ignition timing regardless of whether or not the fuel-cut condition is satisfied.

In the above embodiment, after the ignition timing is retarded to the predetermined value θ1, the ignition timing is further retarded to the predetermined value θ2 when the fuel is cut, but the retard of the ignition timing to the predetermined value θ2 may not be performed regardless of the presence or absence of the fuel-cut. That is, the ignition timing may be retarded to a predetermined value θ1 at the maximum.

In the above embodiment, the shift command detector 39 is adapted to detect the torque-up command, the configuration of a torque-up command detector is not limited thereto. For example, a torque-up request may be made to release a tire lock when a tire is locked due to negative acceleration caused by the fuel-cut during traveling on a road surface having a low coefficient of friction. In this case, the torque-up request may be detected. Since the amount of retard of the ignition timing is correlated with the amount of torque down of the engine 1, the retard instruction value may be converted into a torque down instruction value, thereby controlling the engine torque.

For example, if the torque down instruction value smaller than the torque down instruction value for generating the combustion sound (degree of torque down is large) is input (e.g., when the upshift is requested after the accelerator opening is 0), it is sufficient to control the engine torque in accordance with the smaller torque down instruction value.

In the engine 1 of the above embodiment, the valve mechanism 20 may be configured in a manner that the opening and closing timing of the exhaust valve 16 can be changed. As a result, the crank angle θa in FIG. 3 can be shifted, so that the afterburning of the air-fuel mixture can be further promoted. In the above embodiment, the catalyst temperature is detected by the catalyst temperature sensor 37, and the turbine temperature is detected by the turbine temperature sensor 38. Although each of these temperatures may be estimated by the detected values of the sensors 37 and 38, when estimating each temperature, in the operating state such that the deviation between the detected value and the estimated value is increased, temperature estimation may not be performed. For example, the temperature estimation is not performed immediately after starting or restarting the engine 1 or the like, after an elapse of a predetermined time from the start or restart of the engine 1, the temperature estimation may be performed.

The present invention can be configured as an internal combustion engine control method for controlling an internal combustion engine including a fuel supply part configured to supply a fuel into a combustion chamber in a cylinder and an ignition part configured to ignite a mixture containing the fuel supplied into the combustion chamber. The internal combustion engine control method, includes: detecting at least one of a rotational speed of the internal combustion engine and an amount of an intake air supplied into the combustion chamber or a physical amount having a correlation with the at least one of the rotational speed and the amount of the intake air; detecting a command of a deceleration of a vehicle on which the internal combustion engine is mounted or a command of a decrease of a torque output from the internal combustion engine; controlling the fuel supply part and the ignition part; and determining whether a retard condition of an ignition timing is satisfied based on the rotational speed, the amount of the intake air or the physical amount detected in the detecting when the command is detected. The controlling includes controlling the ignition part so as to perform an ignition-timing retard control to delay the ignition timing of the ignition part when it is determined that the retard condition is satisfied.

The above embodiment can be combined as desired with one or more of the above modifications. The modifications can also be combined with one another.

According to the present invention, it is possible to generate a good exhaust sound that increases a comfort of a driver.

Above, while the present invention has been described with reference to the preferred embodiments thereof, it will be understood, by those skilled in the art, that various changes and modifications may be made thereto without departing from the scope of the appended claims.

What is claimed is:

1. An internal combustion engine control apparatus for controlling an internal combustion engine including a fuel supply part configured to supply a fuel into a combustion chamber in a cylinder and an ignition part configured to ignite a mixture containing the fuel supplied into the combustion chamber,
the internal combustion engine control apparatus, comprising:
a rotational speed sensor configured to detect a rotational speed of the internal combustion engine or a physical amount having a correlation with the rotational speed;
an intake air amount sensor configured to detect an amount of an intake air supplied into the combustion chamber or a physical amount having a correlation with the amount of the intake air;
a command detector configured to detect a command of a deceleration of a vehicle on which the internal combustion engine is mounted or a command of a decrease of a torque output from the internal combustion engine; and
an electronic control unit including a microprocessor and a memory connected to the microprocessor, wherein
the microprocessor is configured to perform:
controlling the fuel supply part and the ignition part; and
determining whether a retard condition of an ignition timing is satisfied based on a value detected by the rotational speed sensor or the intake air amount sensor when the command is detected by the command detector, and wherein
the microprocessor is configured to perform
the controlling including controlling the ignition part so as to perform an ignition-timing retard control to delay the ignition timing of the ignition part when it is determined that the retard condition is satisfied.

2. The internal combustion engine control apparatus according to claim 1, wherein
the microprocessor is configured to perform
the determining including determining that the retard condition is satisfied when the rotational speed of the internal combustion engine detected by the rotational speed sensor is greater than or equal to a predetermined rotational speed.

3. The internal combustion engine control apparatus according to claim 1, wherein
the microprocessor is configured to perform
the determining including determining that the retard condition is satisfied when the amount of the intake air detected by the intake air amount sensor is less than or equal to a predetermined amount.

4. The internal combustion engine control apparatus according to claim 2, further comprising
a temperature sensor configured to detect a temperature of the internal combustion engine, wherein
the microprocessor is configured to perform
the determining including determining that the retard condition is satisfied under a condition that the temperature of the internal combustion engine detected by the temperature sensor is higher than or equal to a predetermined temperature.

5. The internal combustion engine control apparatus according to claim 2, the internal combustion engine further including an exhaust catalyst device configured to purify an exhaust of the internal combustion engine, wherein
the internal combustion engine control apparatus further comprises
a temperature sensor configured to detect a temperature of the exhaust catalyst device, and
the microprocessor is configured to perform
the determining including determining that the retard condition is satisfied under a condition that the temperature of the exhaust catalyst device detected by the temperature sensor is higher than or equal to a predetermined temperature.

6. The internal combustion engine control apparatus according to claim 2, wherein
the microprocessor is configured to perform
the controlling including determining whether the retard condition is satisfied within a predetermined time period after the command is detected by the command detector, and controlling the ignition part so as to perform the ignition-timing retard control when determining that the retard condition is satisfied within the predetermined time period.

7. The internal combustion engine control apparatus according to claim 1, wherein
the cylinder is a plurality of cylinders including a first cylinder and a second cylinder, and
the microprocessor is configured to perform
the controlling including controlling the ignition part provided in each of the first cylinder and the second cylinder so as to perform the ignition-timing retard control in the each of the first cylinder and the second cylinder when it is determined that the retard condition is satisfied.

8. The internal combustion engine control apparatus according to claim 1, wherein
the cylinder is a plurality of cylinders including a first cylinder and a second cylinder, and
the microprocessor is configured to perform
the controlling including controlling the ignition part provided in each of the first cylinder and the second cylinder so as to perform the ignition-timing retard control in the first cylinder and so as not to perform the ignition-timing retard control in the second cylinder when it is determined that the retard condition is satisfied.

9. The internal combustion engine control apparatus according to claim 7, wherein
the plurality of cylinders include a first group cylinder belonging to a first group and a second group cylinder belonging to a second group,
the first group cylinder includes a plurality of the first cylinders, and
the second group cylinder includes a plurality of the second cylinders.

10. The internal combustion engine control apparatus according to claim 7, wherein
the microprocessor is configured to further perform
determining whether a fuel-cut condition is satisfied, and
the controlling including controlling the fuel supply part so as to perform a fuel-cut for the first cylinder and so as not to perform the fuel-cut for the second cylinder when it is determined that the fuel-cut condition is satisfied.

11. The internal combustion engine control apparatus according to claim 7, wherein
the microprocessor is configured to further perform
determining whether a fuel-cut condition is satisfied, and
the controlling including controlling the fuel supply part so as to perform a fuel-cut for the second cylinder and so as not to perform the fuel-cut for the first cylinder when it is determined that the fuel-cut condition is satisfied.

12. The internal combustion engine control apparatus according to claim 10, wherein
the microprocessor is configured to perform
the controlling including controlling the ignition part and the fuel supply part so as to perform the fuel-cut for the first cylinder after performing the ignition-timing retard control when it is determined that both of the retard condition and the fuel-cut condition are satisfied.

13. The internal combustion engine control apparatus according to claim 1, the vehicle including a input part operated by a driver to input a required driving force for the vehicle, and a transmission connected to an output shaft of the internal combustion engine, wherein
the command detector is configured to detect an operation of the input part or a shift command to the transmission.

14. The internal combustion engine control apparatus according to claim 1, wherein
the microprocessor is configured to perform
the controlling including controlling the ignition part so as to continuously perform the ignition-timing retard control for a predetermined time when it is determined that the retard condition is satisfied.

15. The internal combustion engine control apparatus according to claim 14, further comprising
a torque-up command detector configured to detect a torque-up command, wherein
the microprocessor is configured to perform
the controlling including controlling the ignition part so as to stop the ignition-timing retard control when the torque-up command is detected by the torque-up command detector before the predetermined time elapses from a start of the ignition-timing retard control.

16. An internal combustion engine control method for controlling an internal combustion engine including a fuel supply part configured to supply a fuel into a combustion chamber in a cylinder and an ignition part configured to ignite a mixture containing the fuel supplied into the combustion chamber,
the internal combustion engine control method, comprising:
detecting at least one of a rotational speed of the internal combustion engine and an amount of an intake air supplied into the combustion chamber or a physical amount having a correlation with the at least one of the rotational speed and the amount of the intake air;
detecting a command of a deceleration of a vehicle on which the internal combustion engine is mounted or a command of a decrease of a torque output from the internal combustion engine;
controlling the fuel supply part and the ignition part; and
determining whether a retard condition of an ignition timing is satisfied based on the rotational speed, the amount of the intake air or the physical amount detected in the detecting when the command is detected, wherein
the controlling includes controlling the ignition part so as to perform an ignition-timing retard control to delay the ignition timing of the ignition part when it is determined that the retard condition is satisfied.
